(19) United States
(12) Patent Application Publication
(10) Pub. No.: US 2018/0147036 A1
(43) Pub. Date: May 31, 2018

(54) METHOD FOR POSITIONING PROSTHETIC TEETH IN A DENTURE BASE

(71) Applicant: Kulzer GmbH, Hanau (DE)

(72) Inventor: Uwe Boehm, Hanau (DE)

(21) Appl. No.: 15/570,772

(22) PCT Filed: Apr. 26, 2016
(86) PCT No.: PCT/EP2016/059315

§ 371 Date: Oct. 31, 2017

(30) Foreign Application Priority Data
May 5, 2015 (DE) 10 2015 107 006.5

(51) Int. Cl. A61C 13/103; A61C 13/01; A61C 13/08

(52) U.S. Cl. CPC A61C 13/1009; A61C 13/08; A61C 13/01

(57) ABSTRACT

The invention relates to a method for the positioning of prosthetic teeth in a denture base, wherein at least one respective recess is provided in the basal side of the prosthetic teeth and/or a plurality of recesses are provided in the denture base in the surface pointing in the occlusal direction, wherein the prosthetic teeth are connected to the denture base by inserting pins into the recesses, wherein the pins are arranged at the basal side of the prosthetic teeth and/or in the occlusal direction on the denture base and/or the pins are connected as separate retaining pins to the prosthetic teeth and the denture base, wherein the pins have engaging means and the recesses have corresponding counter engaging means, such that, during insertion, the pins lock with the recesses in such a way that the prosthetic teeth are pulled by a mechanical tension against the denture base and connected to the denture base.

The invention also relates to a prosthetic tooth, a set of prosthetic teeth and a denture base for carrying out the method.

The invention relates to a method for the positioning of prosthetic teeth in a denture base, and, respectively, a method for producing a dental prosthesis and a prosthetic tooth, a denture base, and a set of prosthetic teeth for implementing the method.

The invention therefore relates to the positioning and securing of prosthetic teeth in a denture base, as well as the production of a partial or total dental plastic prosthesis. In this situation, preformed prosthetic teeth and, in particular, the denture base can be produced mechanically in a CAM process (CAM—Computer-Aided Manufacturing) and designed with computer support by means of a CAD process (CAD—Computer-Aided Design). The combination of such processes is designated as CAD/CAM processes, with which both the design and the manufacture are carried out with the aid of computers. The prosthetic teeth can be provided as semi-finished products for the partial or complete production of dental plastic prostheses by means of CAM processes.

The present conventional method is the analog positioning of prosthetic teeth for the production of dental prostheses, with which first of all an impression of the toothless jaw of the patient is taken. From this impression, a plaster model of the patient's situation is prepared. Next, a function model of the dental prosthesis made of wax is built up on the plaster model and fitted with prosthetic teeth. This wax prosthesis goes to the dentist, in order to carry out a test fitting on the patient, at which time the positions of the artificial prosthetic teeth can be corrected. This corrected arrangement then goes back to the laboratory, which then removes the wax base and transfers the arrangement of the artificial teeth into a final base made of plastic. For this purpose, a hollow mold or cast mold is built up from both parts, into which the prosthetic teeth are already integrated. In this way the prosthetic teeth are already inserted into the hollow mold and therefore positioned. The mold is cast with a plastic in the color of the gum, and during the casting process the prosthetic teeth are connected to the denture base. After the hardening of the plastic it undergoes subsequent processing in order to obtain the desired form and shape.

Finished denture bases can also be produced from a hardening plastic with an intermediate base made of wax. In this situation, after the test fitting and possible adjustment of the artificial prosthetic teeth, a front wall of silicone or plaster is created in order to secure the position and alignment of the artificial teeth. After this the wax base is removed, the resultant cavity is filled, as a rule with autopolymer, and the artificial prosthetic teeth thereby fixed or polymerized onto the solid denture base.

The whole of this type of process is very time-intensive, and therefore cost-intensive, and is based on a large number of skilled working steps. In the course of digitalization, the effort and expenditure shifts to the production, setting up, and design of the denture bases and of the prosthetic teeth to form the CAD model and the actual production is carried out by machines (CAM machines).

With the setting up of preformed prosthetic teeth, these are adjusted and ground by the dental technician to match the respective oral situation of the patient. There are already initial methods such as, for example, the methods known from DE 10 2009 056 752 A1 or WO 2013 124 452 A1, with which the part or total dental prosthesis is set up digitally and produced by means of CAD/CAM processes. The problem of the connection, including the possibility of correction, however, persists in the conventional as well as in the digital process.

A CAD/CAM process for the production of a dental prosthesis is known from WO 91/07141 A1, wherein, with this method, a denture base is milled out of a plastic block on the basis of an impression.

U.S. Pat. No. 4,175,322 A1 and U.S. Pat. No. 4,184,253 A1 disclose methods, with which two or three parts of a full prosthesis are movable in a wax base relative to one another, in order to be able to adjust the full prosthesis to the shape of the oral cavity of the patient.

The disadvantage of the known methods is the play incurred with the positioning of the prosthetic teeth in the denture base. As a rule, due to this an exactly fitting depression is prepared beforehand in a denture base, in order then to adhesively bond the preformed teeth in it. The adhesive with which the prosthetic teeth are secured in the depressions of the denture base projects, i.e. it has a certain thickness which to an extent cannot be predetermined. This results in the height, position, and orientation of the prosthetic teeth, and, due to the changed height of the prosthetic teeth, the occlusion of the prosthetic teeth no longer being in concordance with the desired height or the desired occlusion. This leads to the situation in which the prosthetic teeth must be ground in the coronal region in the actual finished dental prosthesis, which causes additional work and may impair the visual impression of the coronal ends of the prosthetic teeth. With a digitally produced prosthesis, therefore, the difficulty arises that, after the bonding, for example the adhesive bonding of the teeth in the denture base, they should then be positioned in the three spatial directions x, y, z, and also with regard to the orientation, i.e. a possible rotation or tilting of the prosthetic teeth, such that the individual occlusion of a patient is fulfilled, since the quantity of the securing means can fluctuate during securing, depending on the pressure exerted. This can therefore lead to errors incurred by the assembly.

The object of the invention is therefore to overcome the disadvantages of the prior art. In particular, a method is to be provided, as well as a prosthetic tooth, a set of prosthetic teeth, and a denture base, with which the prosthetic teeth can be connected, as precisely as possible with regard to occlusion, to the denture base, without subsequent adjustment working being necessary, or as few subsequent working steps as possible are needed. If possible, a test fitting of a prefabricated dental prosthesis should be possible which corresponds as precisely as possible to the finished dental prosthesis, i.e. without the occlusion being changed during the production of the finished dental prosthesis, i.e. due to the adhesive bonding of the prosthetic teeth. Moreover, it should be possible for modern production processes, such as CAD/CAM processes, to be applied as effectively as possible, and, respectively, for it to be possible for the advantages which such CAD/CAM-based processes offer to also be used with the method, prosthetic teeth, and denture bases according to the invention.

The objects of the invention are achieved by a method for the positioning of prosthetic teeth in a denture base, in which at least one respective recess is provided in the basal side of the prosthetic teeth and/or a plurality of recesses are provided in the denture base in the surface pointing in the occlusal direction, wherein the prosthetic teeth are connected to the denture base by inserting pins into the recesses,

wherein the pins are arranged at the basal side of the prosthetic teeth and/or in the occlusal direction on the denture base and/or the pins are connected as separate retaining pins to the prosthetic teeth and the denture base,

wherein the pins have engaging means and the recesses have corresponding counter engaging means, such that, during insertion, the pins lock with the recesses in such a way that the prosthetic teeth are pulled by a mechanical tension against the denture base.

The pins and the recesses can exhibit a cylindrical or also a conical symmetry. With conical symmetry, the diameter (apart from the engaging means or the counter engaging means) should as far as possible not increase towards the tip of the pin or towards the basal side of the recess, in order to allow or facilitate the insertion of the pins into the recesses. The recesses can be simple boreholes or also milled holes with a non-rotationally symmetrical symmetry.

The engaging means and the counter engaging means should, according to the invention, be mechanical engaging means and mechanical counter engaging means.

It can preferably be provided with methods according to the invention that, during insertion of the pins into the recesses, the prosthetic teeth are fixed in the denture base without any play.

In this way the situation is attained that the positions and locations of the prosthetic teeth against the denture base are determined without any uncertainty.

With methods according to the invention it can be provided that the recesses are cylindrical apart from the counter engaging means, and preferably exhibit a straight cylindrical geometry apart from the counter engaging means.

The cylindrical form is the simplest which is realizable with the recesses and the pins. The term cylindrical recess or cylindrical pin is to be understood geometrically as a recess or a pin in the form of a general cylinder with any desired base surface, i.e. not only one with a circular base surface. The inner wall of the recess can therefore be a cylinder with any desired base surface and the casing of the cylindrical pin can be a cylinder with any desired base surface, i.e. also with a non-circular or non-round base surface. According to the invention, a cylindrical geometry with a non-rotationally symmetrical base surface is preferred.

It can further be provided that the recesses and the pins exhibit forms which fit one another. This means, in particular, that the recesses form to more than 80% negative forms of the pins, with which the forms deviate from one another by less than 0.5 mm, such that, with the complete insertion of the pins into the recesses, the intermediate space between the pins and the recesses in the region of at least 80% of the surface of the pins is smaller than 0.5 mm.

Due to the matching forms, intermediate gaps of any substantial size can be avoided between the pins and the recesses, which, on the final connecting of the prosthetic teeth to the denture base, would otherwise have to be filled with adhesive. Additionally, the positioning of the pins in the recesses is facilitated by guiding the pins in the recesses.

With a further development according to the invention it can be provided that each pin and each recess exhibits a distinctive form, such that in each case only one pin fits each recess.

In this way it is ensured that the prosthetic teeth cannot be inserted at incorrect positions in the denture base.

It can further be provided that the recesses and the pins are not rotationally symmetrical, and preferably do not exhibit any rotational symmetry axis.

In this way it is ensured that the prosthetic teeth cannot be inserted into the denture base in an incorrect orientation.

It is also proposed that the counter engaging means are arranged on a lateral surface of the recesses. It can also be preferably provided in this situation that the engaging means are arranged on a lateral surface of the pins.

This allows for a firm retention to be achieved on the securing of the prosthetic teeth to the denture base. The lateral surface of the recess is the surface of the recess which does not form the floor or base of the recess. Correspondingly, the lateral surface of the pin is the surface of the pin which is not the face side or the tip of the pin. The engaging means and the counter engaging means engage with one another, according to the invention, preferably in an elastically deformed state, in order for the prosthetic teeth to be drawn into or towards the denture base with a mechanical tension.

It can also be provided that the engaging means are formed by projections, in particular by beads, grooves, spherical sections or hooks, and the counter engaging means are formed by engagement recesses or engagement projections, in particular by grooves or by negative forms of the engaging means.

In this way a secure seating can be achieved. In the simplest form, the projections are formed from the same material as the material the pins, the prosthetic teeth, or the denture base is/are also made of. The prosthetic teeth, the denture base, or the retaining pins preferably consist in each case of only one material, and are configured as being of one piece.

The projections can project by up to 1 mm, preferably between 0.01 mm and 1 mm, and particularly preferably between 0.05 mm and 0.5 mm. The engagement recesses are correspondingly preferably between 0.01 mm and 1 mm deep, particularly preferably between 0.05 mm and 0.5 mm deep.

Preferred configurations of methods according to the invention can also provide that the recesses and/or the pins in the denture base are arranged in receiver surfaces for the prosthetic teeth, preferably in receiver recesses for the prosthetic teeth, wherein the receiver surfaces form negatives of the basal ends of the prosthetic teeth.

In this way a stable connection of the prosthetic teeth with the denture base can be achieved, in particular during the final connection of the prosthetic teeth to the denture base, for example by adhesive bonding. In addition, in this way the position and the location of the prosthetic teeth can also be determined by the shape of the receiver surfaces or receiver recesses respectively, and thereby the performance of the method simplified for the user.

In order to carry out a test fitting on the patient, it can be provided that the prosthetic teeth are detachably connected to the denture base for the purpose of said test fitting.

In this way, prosthetic teeth which are poorly positioned with regard to the occlusion of the dental prosthesis can be rectified or replaced. The advantage here is that, due to the mechanical tension with which the prosthetic teeth are secured in the denture base, their location is determined in a specific and in a reproducible manner, such that, during the later adhesive bonding of the prosthetic teeth to the denture base, the same positions and also the same orientations will be adopted again without the adhesive being applied and, as a result of that, the positions of the prosthetic teeth possibly being changed.

It can further be provided that the denture base and/or the prosthetic teeth are produced as one piece with the recesses or with the recesses and the pins by means of a CAD/CAM process.

As a result of this, the method is further automated, and therefore made easier for the user. In addition, recesses and, as appropriate, pins can be produced which match the treatment situation and therefore connect in a particularly stable manner. By means of the arrangement and the depth of the recesses, an influence can be exerted on the position precision and the stability of the connection of the prosthetic teeth in relation to the denture base.

According to a preferred further development of the invention it can be provided that the intermediate space between the recesses and the associated pins is selected in such a way, or produced in such a way, that a defined quantity of adhesive is adsorbed when the pins are locked with the recesses.

In particular with the use of a CAD/CAM process for producing the prosthetic teeth and the denture base respectively, the intermediate spaces can be precisely calculated, in order in this way to be able to fill in a specific and defined adhesive volume, which is suitable for the bonding of the prosthetic teeth in the denture base. According to the invention, this defined quantity of the adhesive is preferably specified. As a result, the possibility can be avoided that too much adhesive, or even surplus adhesive, swells out of the intermediate spaces at the time of the connection and must then be removed.

It can also be provided that the engaging means are arranged at the pins and the counter engaging means are arranged at the recesses in such a way that the prosthetic teeth can only be connected to the denture base in a specific orientation.

As a result, the situation can be achieved that, during the insertion, when the prosthetic teeth engage in the denture base, which is noticeable by a short jolt of the prosthetic teeth and the denture base respectively, it is ensured that the prosthetic teeth are secured in the correct orientation in the denture base.

It can also preferably be provided that in each case one pin is arranged at the basal ends of the prosthetic teeth, and a plurality of recesses are arranged in the denture base, wherein preferably plugs are provided on the lateral surfaces of the pins as engaging means and grooves are provided on the lateral surfaces as counter engaging means.

As a result, the application is particularly easy and the entire structure is particularly stable.

The objects underlying the invention are also achieved by a method for producing a dental prosthesis, in which the prosthetic teeth are positioned in the denture base by means of a method according to the invention, wherein the prosthetic teeth are adhesively bonded to the denture base, optionally after the test fitting. A cementing of the prosthetic teeth to the denture base is an adhesive bonding within the framework of the present invention.

This then completes the method for producing the dental prosthesis. The advantages which arise from the positioning of the prosthetic teeth are specifically also advantageous for the production of a dental prosthesis. Preferably, the intermediate spaces between pins and the recesses, as well as between the prosthetic teeth and the denture base, are entirely filled with adhesive. This therefore avoids holes and gaps which could impair the stability of the dental prosthesis and in which otherwise food residues could become lodged.

The objects underlying the present invention are further achieved by a prosthetic tooth for the implementation of a method according to the invention, wherein the prosthetic tooth comprises at the basal end at least one pin with an engaging means or at least one recess with a counter engaging means.

Prosthetic teeth according to the invention can be characterized by one or more of the features which are described heretofore or hereinafter in relation to the method according to the invention with regard to the prosthetic teeth.

The objects underlying the present invention are likewise achieved by a set of prosthetic teeth with a plurality of different prosthetic teeth according to the invention.

Finally, the objects underlying the present invention are also achieved by a denture base for the implementation of a method according to the invention, wherein the denture base comprises, in the surface pointing in the occlusal direction, at least one pin with an engaging means and/or at least one recess with a counter engaging means, wherein preferably the at least one pin and/or the at least one recess are arranged in a receiver surface or in a plurality of receiver surfaces for prosthetic teeth.

According to the invention, the denture base preferably comprises a plurality of pins and/or a plurality of recesses.

Denture bases according to the invention, can be characterized by one or more of the features which are described heretofore or hereinafter with regard to the method according to the invention in respect of the denture bases.

The invention is based on the surprising finding that, due to the clamping matching fitting incurred due to the engagement of the engaging means into the counter engaging means on the connecting of the prosthetic teeth to the denture base, it is possible for the position and orientation of the prosthetic teeth to be adjusted in a reliable and reproducible manner, in particular the height (z direction) of the prosthetic teeth, which is important for the occlusion. Due to the mechanical tension between the denture base and the prosthetic teeth, the situation is achieved that these are moved into the desired position, even if an adhesive such as, for example, a PMMA cement, is present between the denture base and the prosthetic teeth. In this way it is ensured that no change of position of the prosthetic teeth occurs relative to the denture base due to the adhesive or connecting means respectively.

With previous solutions, the surface between prosthetic tooth and denture base is individual, and there is no guarantee that the prosthetic teeth, in particular in the z-axis (i.e. in the height important for the occlusion), are in the correct location, which can lead to overbite or underbite.

In order to achieve an exact positioning in the x-y-z direction, use is made according to the invention of grooves, undercuts, retentions, or similar. For this purpose, there can be provided, in the recesses and/or the pins, continuous channels, non-continuous channels, individual points, teeth, wedges, i.e. generally engagement projections and engagement recesses, which then engage mutually under mechanical tension. The recesses can be provided in the denture base and/or in the prosthetic teeth. The borehole is preferably provided in the prosthetic tooth.

Hereinafter exemplary embodiments of the invention are explained on the basis of five schematically represented figures, but without thereby restricting the invention, wherein:

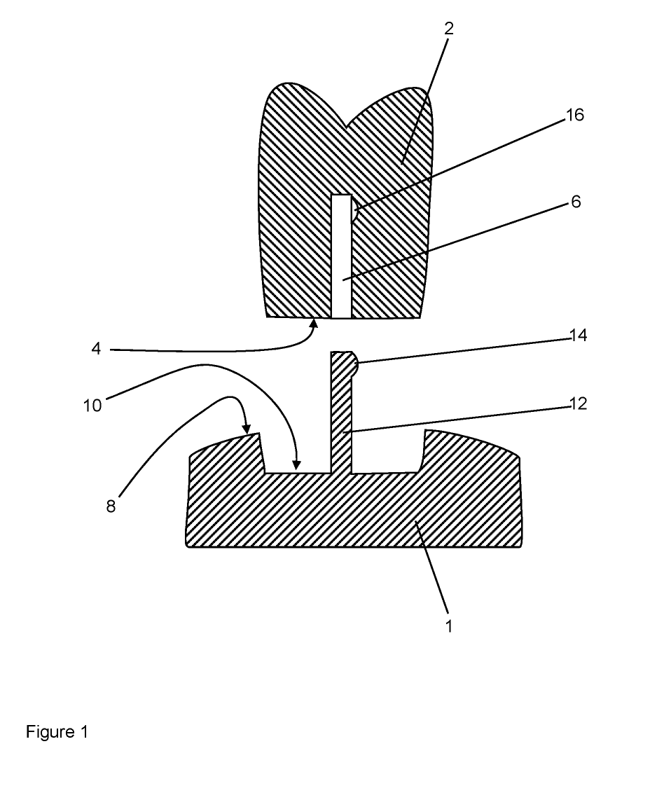

FIG. 1 shows a schematic cross-section view of a prosthetic tooth and of a denture base for the implementation of a method according to the invention;

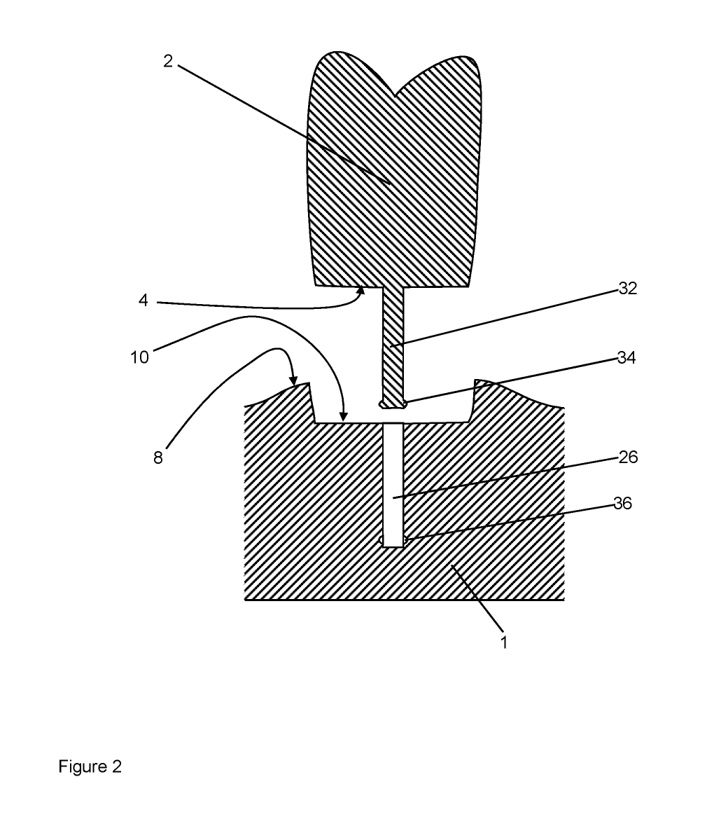

FIG. 2 shows a schematic cross-section view of a prosthetic tooth and a denture base for the implementation of a method according to the invention, with an alternative connection possibility;

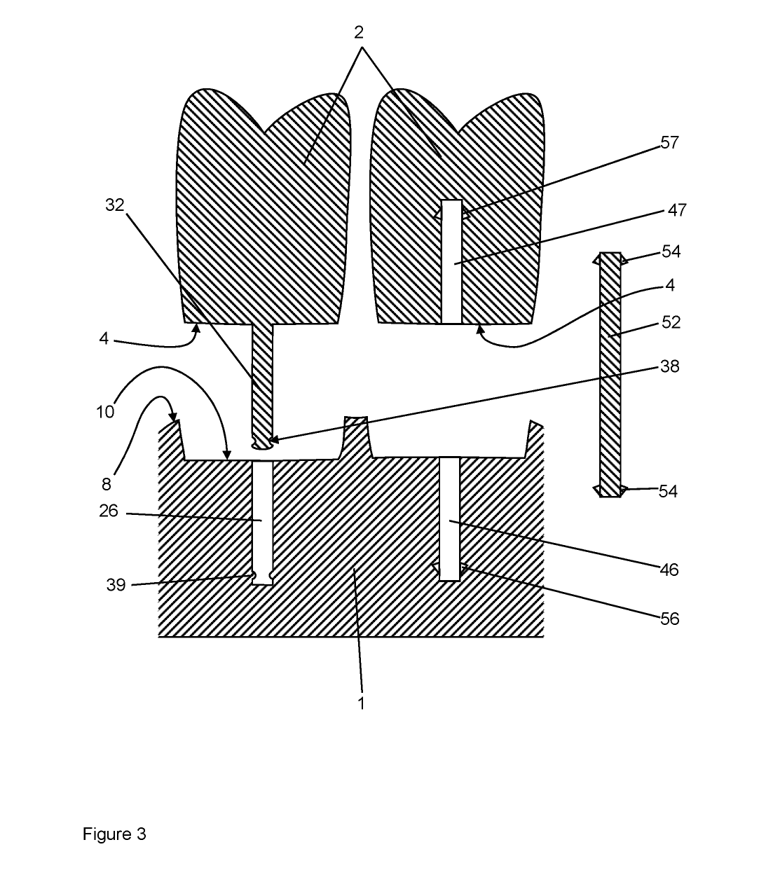

FIG. 3 shows a schematic cross-section view of two prosthetic teeth and a denture base for the implementation of a method according to the invention, with two further connection possibilities according to the invention;

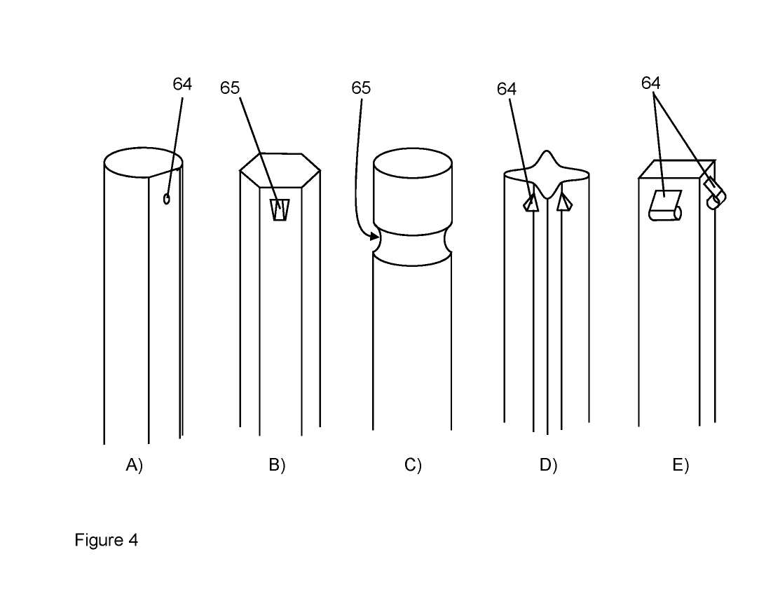

FIG. 4 shows schematic perspective views of five different ends of pins (A to E) for the implementation of a method according to the invention;

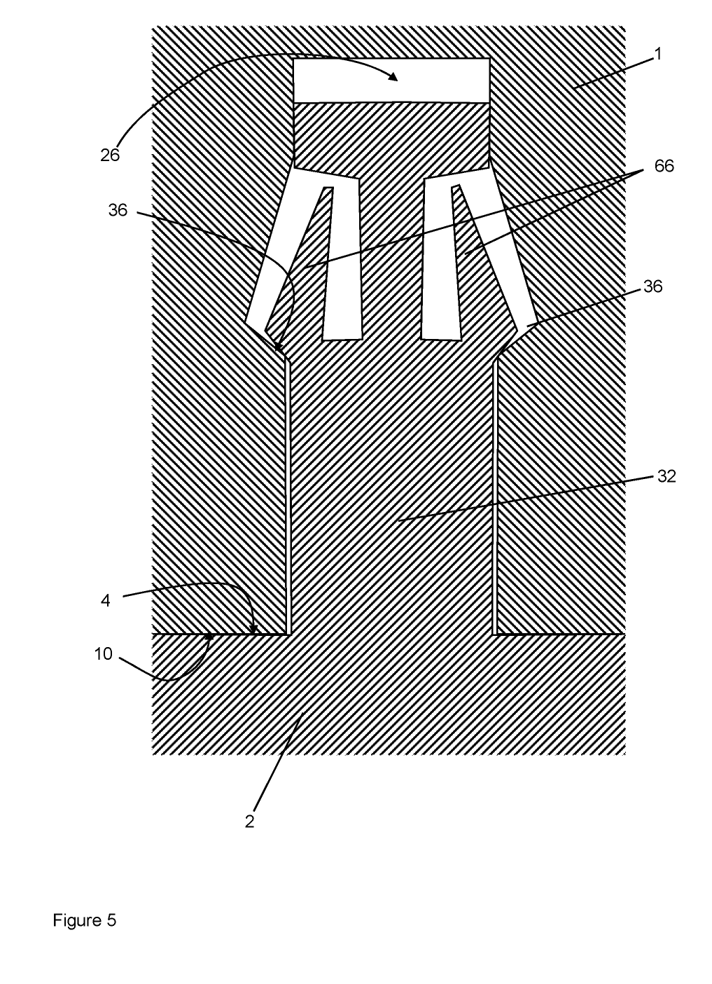

FIG. 5 shows a schematic cross-section view of an extract of a mechanically tensioned connection between a prosthetic tooth and a denture base, in order to clarify the implementation of a method according to the invention; and

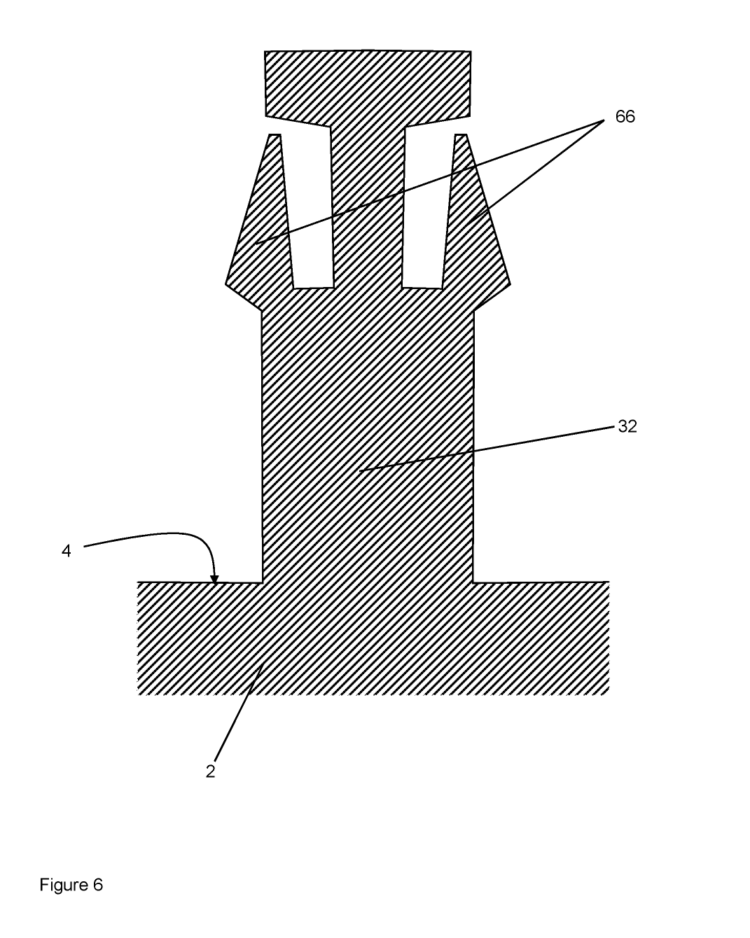

FIG. 6 shows a schematic cross-section view of the mechanically tensioned engaging means.

In the figures, in the case of different embodiments, the same reference numerals are used in part for parts of the same type, in particular for engaging means of the same type but differing in detail. Sectionally cut surfaces are represented as shaded sections in the figures.

FIG. 1 shows a schematic cross-section view of a denture base 1 and of a prosthetic tooth 2 for the implementation of a method according to the invention. Provided in the basal end 4 of the prosthetic tooth 2 is a recess 6 in the form of a cylindrical hole. Provided opposite the prosthetic tooth 2, in the denture base 1 is a receiver surface 10 or, respectively, a receiver recess 10, in order to receive the prosthetic tooth 2. The receiver surface 10 is arranged in the surface 8 of the denture base 1 which is aligned in the occlusal direction. The receiver surface 10, or the receiver recess 10 respectively, forms a negative of the basal end of the prosthetic tooth 2. Provided on the receiver surface 10 is a cylindrical pin 12, which fits exactly into the recess 6 of the prosthetic tooth 2. The cylindrical pin 12 preferably projects perpendicularly from the receiver surface 10, particularly preferably at 90° with a maximum deviation of 10°. It may be pointed out that, in the present case, the term cylindrical geometry, therefore also the term cylindrical recess 6 or cylindrical pin 12, is to be understood as the geometric form of a general cylinder with any desired base surface, i.e. not only a cylinder with a circular base surface.

Provided at the pin 12 is an engaging means 14, which engages in a counter engaging means 16 in the recess 6 when the pin 12 is inserted fully into the recess 6. The pin 12, the engaging means 14, and the denture base 1, are made of one piece from a pink-colored plastic such as, for example, PMMA (polymethyl methacrylate), and preferably produced by means of a CAD/CAM process. The engaging means 14 is arranged as a spherical section on the surface of the pin 12, and projects over the cylindrical lateral surface of the pin by 0.01 mm to a maximum of 1 mm, preferably by 0.05 mm to 0.4 mm. The counter engaging means 16 is correspondingly a hollow form which can receive the engaging means 14, preferably an engagement recess 16 in the form of the negative of the spherical section of the engaging means 14. Specifically, a rotation of the prosthetic tooth 2 in the denture base 1 about the cylindrical axis of the pin 12 or of the recess 6 respectively is no longer automatically possible, and the intermediate space between the assembled prosthetic tooth 2 and the denture base 1 remains small. For the definitive securing of the orientation of the prosthetic tooth 2 in the denture base, use can also be made of a specific form of the receiver surface 10, onto which the prosthetic tooth 2 is to be placed in flush contact connection in only one specific orientation.

The engaging means 14 at the pin 12 and the pin 12 itself, and, to a lesser extent also the prosthetic tooth 2, and therefore the recess 6, are elastically deformable, such that the pin 12 is insertable, with the engaging means 14, into the recess 6, in that the engaging means 14 are elastically compressed. As soon as the engaging means 14 engage into the counter engaging means 16, the compressed engaging means 14 is relaxed (not necessarily completely, or preferably not completely), and to a slight degree the expanded recess 6 also relaxes. The engaging means 14 is in this case arranged at a slightly lesser height at the pin 12 than the counter engaging means 16 in the recess 6. As a result, the engaging means 14 cannot relax entirely, and the residual tension draws the prosthetic tooth 2 in the direction of the denture base 1. Already sufficient for this is a height difference between the engaging means 14 and the counter engaging means 16 of 0.1 mm, but it is also possible, depending on the geometry of the engaging means 14 and of the counter engaging means 16, for greater height differences to also be selected.

In order for the mechanical tension to build up, the engaging means 14 and the counter engaging means 16 are configured with surfaces inclined towards one another, which in the present case are realized by the roundings of the spherical sections. Due to the rounded form of the engaging means 14 and of the counter engaging means 16, no further element exerting a mechanical tension or a mechanical traction is required.

For the final securing of the prosthetic tooth 2 in the denture base 1, first an adhesive (not shown) is inserted into the recess 6 and/or applied onto the pin 12. The correct seating of the prosthetic tooth 2 during the hardening of the adhesive (for example a PMMA cement (polymethyl methacrylate cement or another two-component adhesive) is guaranteed by the mechanical tension which the engaging means 14 and the counter engaging means 16 exert on one another. As soon as the adhesive has hardened, the prosthetic tooth 2 is secured and the dental prosthesis assembled. Surplus adhesive can be removed before and/or after the hardening of the adhesive. In this situation it is of advantage if the free volume between the prosthetic tooth 2 and the denture base 1 is precisely defined by the seating, and therefore the volume of adhesive required is precisely known. Nevertheless, the adhesive is preferably used to a small degree in surplus, in order to ensure that no cavities or gaps remain between the prosthetic tooth 2 and the denture base 1 which are not filled with adhesive. Likewise, the dental prosthesis can be polished after the hardening of the adhesive, in order to obtain a better visual impression.

Before the final connection, the prosthetic tooth 2 can be separated from the denture base 1 again by the application of suitable force. This can be helpful, for example, in order to test the seating of the dental prosthesis which has been provisionally assembled in this way on the patient (referred to as a test fit). If necessary, the prosthetic tooth 2 can be ground slightly at the basal side to achieve a better fit, provided that this does not incur the complete loss of the mechanical tension between the denture base 1 and the inserted prosthetic tooth 2.

Provided in front and behind the prosthetic tooth 2, shown in section, are further prosthetic teeth (not shown), which are connected in the same way or with an alternative method according to the invention to the denture base 1, such that, with the prosthetic tooth 2, the other prosthetic teeth, and the denture base 1, a partial dental prosthesis or a full dental prosthesis can be produced.

FIG. 2 shows a schematic cross-section view of a prosthetic tooth 2 and a denture base 1 for the implementation of a method according to the invention, with an alternative connection possibility in comparison with FIG. 1. Provided in the denture base 1 is a receiver surface 10 or, respectively, a receiver recess 10 for receiving the prosthetic tooth 2. The receiver surface 10 is arranged in the surface 8 of the denture base, which is aligned in the occlusal direction. The receiver surface 10 or, respectively, the receiver recess 10 forms a negative of the basal end of the prosthetic tooth 2. Provided in the receiver surface 10 of the denture base 1 is a recess 26 in the form of a cylindrical hole. Provided opposite this, on the basal side 4 of the prosthetic tooth 2, is a cylindrical pin 32, which fits precisely into the recess 26 of the denture base 1. The cylindrical pin 32 projects preferably roughly perpendicularly from the basal side 4 of the prosthetic tooth 2, and particularly preferably projects at 90° with a maximum deviation of 20°. It may be pointed out that in the present case the term cylindrical geometry, i.e. also a recess 26 or a cylindrical pin 32, is understood to mean the geometric shape of a general cylinder with any desired base surface, i.e. not only a cylinder with a circular base surface.

Provided at the pin 32 is an engaging means 34, which engages in a counter engaging means 36 in the recess 26 when the pin 32 is inserted entirely into the recess 26. The pin 32, the engaging means 34, and the prosthetic tooth 2 are made as one piece from a tooth-colored plastic such as, for example, PMMA. The denture base 1 is made as one piece from a pink-colored plastic such as, for example, PMMA, and is preferably produced by means of a CAD/CAM process. The engaging means 34 is arranged as a circumferential bead on the surface of the pin 32 in the region of the tip of the pin 32 (bottom in FIG. 2) and projects over the cylinder lateral surface of the pin by 0.01 mm and up to a maximum of 1 mm, preferably by 0.05 mm to 0.4 mm. The counter engaging means 36 is accordingly a hollow ring which can receive the engaging means 34, preferably an engagement recess 36 in the form of the negative of the bead of the engaging means 14. In this way the intermediate space between the assembled prosthetic tooth 2 and the denture base 1 remains small. In order to achieve a distinct positioning and orientation of the prosthetic tooth 2 in the denture base 1, a distinct receiver surface 10 is provided, onto which the prosthetic tooth 2 is to be placed in flush contact connection in only one specific orientation.

The engaging means 34 at the pin 32 and the pin 32 itself, as well as, to a lesser degree also the prosthetic tooth 2 and therefore the recess 26, are elastically deformable, such that the pin 32 with the engaging means 34 is insertable into the recess 26, elastically compressing the engaging means 34. As soon as the engaging means 34 engages into the counter engaging means 36, the compressed engaging means 34 relaxes (not necessarily completely, or preferably not completely), and to a slight degree also the expanded recess 26. The engaging means 34 is in this situation arranged at a slightly lesser height at the pin 32 than the counter engaging means 36 in the recess 26. As a result of this, the engaging means 34 cannot relax entirely, and the remaining mechanical tension draws the prosthetic tooth 2 in the direction of the denture base 1. For this purpose, a height difference between the engaging means 34 and the counter engaging means 36 of 0.1 mm is sufficient, but, depending on the geometry of the engaging means 34 and of the counter engaging means 36, greater height differences can also be selected.

In order for the mechanical tension to be able to build up, the engaging means 34 and the counter engaging means 36 are configured with surfaces inclined towards one another due to the rounding. Due to the rounded shape of the engaging means 34 and of the counter engaging means 36 no further element is required to produce a mechanical tension.

For the final securing of the prosthetic tooth 2 in the denture base 1, first an adhesive (not shown) is introduced into the recess 26 and/or applied onto the pin 32. The correct seating of the prosthetic tooth 2 on the hardening of the adhesive (for example a PMMA cement or another two-component adhesive) is ensured by the mechanical tension which the engaging means 34 and the counter engaging means 36 exert on one another. As soon as the adhesive has hardened, the prosthetic tooth 2 is secured and the dental prosthesis assembled. Surplus adhesive can be removed before and/or after the hardening of the adhesive. In this situation it is of advantage if the free volume between the prosthetic tooth 2 and the denture base 1 is precisely defined by the seating, and therefore the volume of adhesive required is precisely known. Nevertheless, the adhesive is preferably used in a slight amount in excess, in order to ensure that no cavities or gaps remain between the prosthetic tooth 2 and the denture base 1 which are not filled with adhesive. Likewise, the dental prosthesis can be polished after the hardening of the adhesive in order to obtain a better visual impression.

Before the final connection, the prosthetic tooth 2 can be separated from the denture base 1 again by the application of suitable force. This can be helpful, for example, in order to test the seating of the dental prosthesis which has been provisionally assembled in this way on the patient. If necessary, the prosthetic tooth 2 can be ground slightly at the basal side to achieve a better fit, provided that this does not incur the complete loss of the mechanical tension between the denture base 1 and the inserted prosthetic tooth 2.

Provided in front of and behind the prosthetic tooth 2, shown in section, are further prosthetic teeth (not shown), which are connected in the same way or with an alternative method according to the invention to the denture base 1, such that, with the prosthetic tooth 2, the other prosthetic teeth, and the denture base 1, a partial dental prosthesis or a full dental prosthesis can be produced.

FIG. 3 shows a schematic cross-section view of two prosthetic teeth 2 and a denture base 1 for the implementation of a method according to the invention, with two further connection possibilities according to the invention. The cross-section is represented in FIG. 3 in such a way that two prosthetic teeth 2 are visible, and only a sectional part of the denture base 1 is represented, which extends to the right and left. The receiver surfaces 10 for the prosthetic teeth 2, and the prosthetic teeth 2 which relate to them have different securing possibilities. Accordingly, only one specific prosthetic tooth 2 is always obviously to be secured in one specific receiver surface 10.

The connection of the left prosthetic tooth 2 (on the left in FIG. 3) corresponds approximately to the exemplary embodiment according to FIG. 2, wherein the engaging means 38 is provided at the pin 32 as a ring-shaped groove 38, and the counter engaging means 39 is formed in the recess 26 by a projecting ring 39.

The right prosthetic tooth 2 (on the right in FIG. 3) is secured by a separate retaining pin 52 to the right receiver surface 10 of the denture base 1. The retaining pin 52 comprises at both ends a plurality of projecting hooks 54 as engaging means 54. Provided in the right prosthetic tooth 2 is a recess 47 which comprises a plurality of cut-out openings 57 as counter engaging means 57. Likewise provided in the denture base 1, in the right receiver surface 10 is a recess 46 which comprises a plurality of cut-out openings 56 as counter engaging means 56. The recesses 46, 47 fit the retaining pin 52, such that the retaining pin 52 can be inserted into the recesses 46, 47, wherein the engaging means 54 engage in the counter engaging means 56, 57, and the right prosthetic tooth 2 is drawn into the right receiver surface 10 of the denture base 1.

The mechanical tension can be exerted by the elasticity of the retaining pin 52 and/or by additional elastic elements (not shown).

For the correct orientation of the prosthetic teeth 2 and in order to connect the prosthetic teeth 2 to the denture base 1 with the aid of adhesive, reference is made to the embodiment in FIGS. 1 and 2, which is transferable without further ado to the embodiments shown in FIG. 3.

FIG. 4 shows schematic perspective views of five different ends of pins (A to E) for the implementation of methods according to the invention. The first pin, shown in FIG. 4 A), has the form of a straight cylinder with a circular base surface with a cut edge, i.e. the form of a segment of a circle. Provided on the flat cylinder lateral surface as engaging means 64 is a small elastically deformable projection in the form of a flat spherical section.

The second pin, shown in FIG. 4 B), is a straight cylinder with a hexagonal base surface. The form corresponds approximately to that of a hexagon. Provided in one of the lateral surfaces to be seen in FIG. 4 B) is a recess 65, as engaging means 65. This engaging means 65 can comprise an elastically deformable counter engaging means (not shown), which is arranged in a matching hexagonal recess (not shown).

The third pin, shown in FIG. 4 C), has the form of a straight cylinder with a circular base surface. Provided on the cylinder lateral surface as engaging means 65 is a circumferential groove 65 as a negative form of a torus. This groove 65 can receive an elastically deformable counter engaging means (not shown) in the form of a circumferential ring or projection, which is arranged in a matching cylindrical recess with a circular base surface (not shown).

The fourth pin, shown in FIG. 4 D), has the form of a straight cylinder with a star-shaped base surface. Provided in all the corners of the cylinder lateral surface as engaging means 64 are projecting noses 64.

The fifth pin, shown in FIG. 4 E), has the form of a straight cylinder with a rectangular base surface. Provided on the cylinder lateral surface as engaging means 64 is a projecting clasp 64 made of spring steel. The clasp 64 is a curved elastic leaf spring 64, which is connected to the pin. When the pin is inserted, the leaf spring 64 is compressed and rolled in, and expands again when engagement takes place. The disadvantage of this embodiment is the substantial gap between the pin and the recess required for this, such that the other embodiments shown in FIG. 4 are preferred.

Described briefly hereinafter is how, with such pins according to FIG. 4 and with prosthetic teeth 2 and denture bases 1 similar to those shown in FIGS. 1 to 3, a method according to the invention can be carried out.

In the middle of a receiver recess of a denture base, a pin according to FIG. 4 or another pin in the form of a general cylinder can be introduced which has a rotation protection arrangement (for example a straight surface, groove, etc.) and has on the outer surface an engaging means 64, 65 (nose, groove, slots, etc.). At the same time, on the opposite prosthetic tooth there is a recess which matches this, with corresponding opposite side engagement possibilities, i.e. a counter engaging means, and the opposite side rotation protection element. This allows the parts to be optimally placed in relation to one another in the space defined beforehand by the design. The pin is preferably shorter than the recess is deep.

The optimum structural design and positioning in the CAD process can take place before a correction, optimally after a correction, after a test fitting. The cylinder (the pin) can also be provided on the basal surface of the prosthetic tooth, and the recess on the denture base.

Small holes on the securing surface of the prosthetic teeth and the denture base can allow for surplus securing compound (adhesive) to escape, such that the prosthetic teeth are in fact locked at the desired height relative to the denture base.

FIG. 5 shows a schematic cross-section view of a section part of a mechanically tensioned connection between a prosthetic tooth 2 and a denture base 1, in order to clarify the implementation of a method according to the invention. Provided on the basal side 4 of the prosthetic tooth 2 is a pin 32 with an engaging means 66. The engaging means 66 is formed by two (or more) projections which are tiltable against the pin 32 and which are insertable into a cavity at the pin 32 when the pin 32 is introduced into a recess 26 in the denture base 1. During insertion of the pin 32, the engaging means 66 reach a counter engaging means 36 in the recess 26 and can partially relax there. A complete relaxation of the engaging means 66 is prevented, since the basal surface 4 of the prosthetic tooth 2 is already in contact with the receiver surface 10 of the denture base 1.

FIG. 6 shows, in comparison with this, the mechanically relaxed engaging means 66 in a schematic cross-section view before the pin 32 is inserted into the recess 26. As is visible, the engaging means 66 in the relaxed state is tilted radially further outwards than in the tensioned state according to FIG. 5.

With the mechanically tensioned connection represented in FIG. 5, the elastic deformation of the engaging means 66 leads to the engaging means 66 being readily transferred again into the position shown in FIG. 6, relative to the pin 32. As a result, they exert a force onto the front edges of the counter engaging means 36, which leads to the prosthetic tooth 2 being pulled onto the receiver surfaces 10 of the denture base 1. As a result, it is ensured that the prosthetic tooth 2 attains the correct height and therefore the desired occlusion.

The exemplary embodiment according to FIGS. 5 and 6 is simply intended to represent the function principle and the effect of the mechanical tension. Since the dimensions of the prosthetic teeth are relatively small for such a structural arrangement, an elastically compressible engaging means (as in FIGS. 1 and 2) or an elastically compressible counter engaging means (as on the left in FIG. 3) is preferred according to the invention. With regard to the exemplary embodiments according to FIGS. 1 and 2 this means that when the pins 12, 32 are fully inserted into the recesses 6, 26, the engaging means 14, 34 are still somewhat elastically compressed, and would tend to expand further outwards. For that purpose, the engaging means 14, 34 would have to draw the pins 12, 32 deeper into the recesses 6, 26, since the counter engaging means 16, 36 are arranged somewhat deeper in the recesses 6, 26 than the height of the engaging means 14, 34 is on the pins 12, 32. The engaging means 14, 34 therefore expand in the direction of the counter engaging means 16, 36 and, in this way, draw on the pin 12, 32, which conducts the mechanical tension or, respectively, tensile stress thereby incurred onwards between the prosthetic tooth 2 and the denture base 1. The expansion striven for of the elastically compressed engaging means 14, 34 therefore has the effect that the prosthetic tooth 2 is drawn in the direction of the denture base 1 onto the receiver surface 10. As a result, the prosthetic tooth 2 is positioned precisely and exactly on the denture base 1. This positioning also takes place during the adhesive bonding or, respectively, the final securing of the prosthetic teeth 2 in order to produce the dental prosthesis.

As well as the engagement arrangements shown with FIGS. 1 to 6, it would also be possible to use a bayonet closure, which is inserted under tension.

The features of the invention disclosed in the foregoing description as well as in the claims, figures, and exemplary embodiments can be essential, both individually and in any desired combination, for the realization of the invention in its different embodiments. It is understood that the device for the numbers of prosthetic teeth 2 shown, in addition to the exemplary embodiments shown, is transferable without further ado to other quantities of prosthetic teeth 2, wherein the full set of fourteen prosthetic teeth 2 per denture base 1 is preferred for a full dental prosthesis according to the invention.

### LIST OF REFERENCE NUMERALS

1 Denture base
2 Prosthetic tooth
4 Basal end of the prosthetic tooth
6 Recess
8 Surface of the denture base aligned towards the occlusion plane
10 Receiver surface/receiver recess
12 Pin
14 Engaging means/projecting spherical section
16 Counter engaging means/engagement recess as spherical section
26 Recess
32 Pin
34 Engaging means/projecting circumferential bead
36 Counter engaging means/engagement recess as ring-shaped groove
38 Engaging means/engagement recess as ring-shaped groove
39 Counter engaging means/projecting circumferential bead
46 Recess
47 Recess
52 Retaining pin
54 Engaging means/projecting hook
56 Counter engaging means/cut-out opening
57 Counter engaging means/cut-out opening
64 Engaging means/projecting engaging means
65 Engaging means/engagement recess
66 Engaging means

1. A method for the positioning of prosthetic teeth in a denture base, comprising providing at least one respective recess in a basal side of the prosthetic teeth and/or providing a plurality of recesses in the denture base in a surface pointing in an occlusal direction, wherein the prosthetic teeth are connected to the denture base by inserting pins into the recesses, wherein:
the pins are arranged at the basal side of the prosthetic teeth and/or in the occlusal direction on the denture base and/or the pins are connected as separate retaining pins to the prosthetic teeth (2) and the denture base (1), and
the pins have engaging means and the recesses have corresponding counter engaging means, such that, during insertion, the pins lock with the recesses in such a way that the prosthetic teeth are pulled by a mechanical tension against the denture base and connected to the denture base.

2. The method according to claim 1, wherein during insertion of the pins into the recesses, the prosthetic teeth are fixed in the denture base without any play.

3. The method according to claim 1, wherein the recesses are cylindrical apart from the counter engaging means.

4. The method according to claim 1, wherein the recesses and the pins exhibit forms which fit one another.

5. The method according to claim 1, wherein each pin and each recess exhibits a distinctive form, such that in each case only one pin fits each recess.

6. The method according to claim 1, wherein the recesses and the pins are not rotationally symmetrical.

7. The method according to claim 1, wherein the counter engaging means are arranged on a lateral surface of the recesses, and the engaging means are arranged on a lateral surface of the pins.

8. The method according to claim 7, wherein the engaging means are formed by projections, and the counter engaging means are formed by engagement recesses or engagement projections.

9. The method according to claim 1, wherein the recesses and/or the pins in the denture base are arranged in receiver surfaces for the prosthetic teeth.

10. The method according to claim 1, wherein to carry out a test fitting, the prosthetic teeth are detachably connected to the denture base.

11. The method according to claim 1, wherein the denture base and/or the prosthetic teeth are produced as one piece with the recesses or with the recesses and the pins by a CAD/CAM process.

12. The method according to claim 1, wherein an intermediate space between the recesses and the associated pins is selected in such a way, or produced in such a way, that a defined quantity of adhesive is adsorbed when the pins are locked with the recesses.

13. The method according to claim 1, wherein the engaging means are arranged at the pins and the counter engaging means are arranged at the recesses in such a way that the prosthetic teeth can only be connected to the denture base in a specific orientation.

14. The method according to claim 1, wherein in each case one pin is arranged at basal ends of the prosthetic teeth, and a plurality of recesses (26) are arranged in the denture base (1), wherein preferably plugs are provided on lateral surfaces of the pins as engaging means and grooves are provided on the lateral surfaces as counter engaging means.

15. A method for producing a dental prosthesis, comprising positioning the prosthetic teeth in the denture base by a method according to claim 1, wherein the prosthetic teeth are adhesively bonded to the denture base.

16. A prosthetic tooth for the implementation of a method according to claim 1, wherein the prosthetic tooth comprises at a basal end at least one pin with an engaging means or at least one recess with a counter engaging means.

17. A set of prosthetic teeth with a plurality of different prosthetic teeth according to claim 16.

18. A denture base for the implementation of a method according to claim 1, wherein the denture base comprises, in the surface pointing in the occlusal direction, at least one pin with an engaging means and/or at least one recess with a counter engaging means.

19. The method according to claim 3, wherein the recesses exhibit a straight cylindrical geometry apart from the counter engaging means.

20. The method according to claim 6, wherein the recesses and the pins do not exhibit any rotational symmetry axis.

21. The method according to claim 8, wherein the engaging means are formed by beads, grooves, spherical sections, or hooks, and the counter engaging means are formed by grooves or by negative forms of the engaging means.

22. The method according to claim 9, wherein the recesses and/or the pins in the denture base are arranged in receiver recesses for the prosthetic teeth, wherein the receiver recesses form negatives of the basal ends of the prosthetic teeth.

23. A method for producing a dental prosthesis, comprising positioning the prosthetic teeth in the denture base by a method according to claim 15, wherein the prosthetic teeth are adhesively bonded to the denture base after the test fitting.

24. A denture base for the implementation of a method according to claim 18, wherein the at least one pin and/or the at least one recess is or are arranged in a receiver surface or in a plurality of receiver surfaces for prosthetic teeth.
